(19) United States
(12) Patent Application Publication
(10) Pub. No.: US 2015/0176261 A1
(43) Pub. Date: Jun. 25, 2015

(54) VALVE DEVICE FOR WASTE PIPE

(71) Applicant: McAlpine & Co Limited, Glasgow (GB)

(72) Inventor: James Edward McAlpine, Glasgow (GB)

(21) Appl. No.: 14/403,988

(22) PCT Filed: May 28, 2013
(86) PCT No.: PCT/GB2013/000241

§ 371 Date: Nov. 25, 2014

(30) Foreign Application Priority Data
May 28, 2012 (GB) 1209434.8
Nov. 10, 2012 (GB) 1220253.7

(51) Int. Cl. E03C 1/122; F16K 11/10; E03F 7/04

(52) U.S. Cl. CPC E03C 1/1225; E03F 7/04; F16K 11/10

(57) ABSTRACT

Plumbing apparatus (10) for incorporation in a waste pipe system comprises a tubular body having an inlet (14) for connection to an upstream waste pipe and an outlet (16) for connection to a downstream waste pipe. A one-way water valve (22) is provided in the body and is arranged to permit flow from the inlet to the outlet and to prevent flow from the outlet to the inlet. An air valve (24) is mounted on an upper portion of the body and is arranged to permit flow of air into the body and to restrict flow of air out of the body. In the event of negative pressure in the downstream waste pipe system the air valve opens to allow air to be drawn into the system. In the event of positive pressure in the downstream waste pipe system the one-way water valve closes.

### FIELD OF THE INVENTION

This invention relates to plumbing apparatus and in particular to apparatus incorporating a valve for inclusion in a drainage system; and associated methods.

### BACKGROUND OF THE INVENTION

In domestic and commercial premises the outlets from various plumbing fittings and appliances, including wcs, urinals, wash hand basins, baths, washing machines, dishwashers and the like, are linked via appropriate connecting piping into a waste or soil pipe system. In a multi-storey building, such as an apartment block, soil pipes from individual apartment units on different floors typically connect with a common soil stack. In such systems it is not uncommon for pressure imbalances to occur within the system. For example, a large volume flow in the soil stack may induce a negative pressure in parts of the waste pipe system. This may result in air being drawn into the system via upstream fittings, for example through a sink waste. This creates unwelcome noise and may also result in the water in the sink trap being drawn into the waste pipe, such that smells and gases from the waste pipe system may then flow unimpeded into an apartment. Conversely, a large volume flow from the upper floors may also result in a positive pressure in parts of the waste pipe system. This may result in gas in the system being pushed back through plumbing fittings into apartments, with the associated unpleasant noise and smells.

Such problems tend to be periodic and it is unlikely that the particular conditions which induced a problem can be reliably recreated, particularly in a multi-occupancy building. Furthermore, the problems of noise and smells created by negative pressure and by positive pressure in the waste pipe system are often the same and it can be difficult, based on reports by occupants, to accurately analyse the problem, identify its cause, and then devise a solution to prevent its reoccurrence.

### SUMMARY OF THE INVENTION

According to a first aspect of the present invention there is provided plumbing apparatus for incorporation in a waste pipe system, the apparatus comprising:

a tubular body having an inlet for connection to an upstream waste pipe and an outlet for connection to a downstream waste pipe;

a one-way valve in the body arranged to permit flow from the inlet to the outlet and to restrict flow from the outlet to the inlet, and

at least one pressure relief device on a portion of the body arranged to permit the flow of air into the body and to restrict flow of air out of the body.

The apparatus thus protects the waste pipe system from both negative and positive downstream pressure. In the event of negative pressure in the waste pipe system the air valve opens to allow air to be drawn into the system. Thus, fittings and appliances upstream of the apparatus are not exposed to the negative pressure. Similarly, in the event of positive pressure in the downstream waste pipe system the one-way valve closes and fittings and appliances upstream of the apparatus are not exposed to the positive pressure.

As the apparatus solves both potential problems it is not necessary to identify the nature of the problem to provide a complete solution.

The one-way valve may also serve to prevent waste water which has backed up in the downstream waste pipe system passing into the upstream waste pipe system. Again this may be a particular problem in the lower floors of multi-storey apartment buildings, where in extreme situations waste water may flow back into plumbing fittings and then out of the fitting and into apartments, causing distress, damage and potential health problems.

The one-way valve may also serve as a barrier to prevent rodents gaining access to the upstream waste pipe system. This is particularly useful given the increasing use of flexible plumbing connections between plumbing fittings and waste pipe systems; these connections appear to be more prone to rodent attack than conventional rigid connections.

The at least one pressure relief device may be in communication with the body downstream of the one-way valve.

The at least one pressure relief device may be an air valve.

The air valve may be a one way air admission valve.

The valve may comprise a valve member resiliently biased against a seat.

The at least one pressure relief device may be a variable volume expansion chamber.

The variable volume expansion chamber may comprise a bellows.

The bellows is may be mounted on a port open to the interior of the tubular body.

The bellows may be enclosed within a housing.

Alternatively, the variable volume expansion chamber may comprise an elastomeric bladder or a piston and cylinder.

In at least one embodiment, the at least one pressure relief device comprises a pressure relief mechanism.

In a preferred embodiment, the pressure relief device is located on the tubular body such that in a preferred installation orientation, gravitational effects assist the pressure relief mechanism to operate.

In some embodiments, where the preferred installation orientation is horizontal, the pressure relief device is mounted on an upper portion of the tubular body.

In at least one embodiment, the at least one pressure relief device may be rotatably mounted to the tubular body. Such an arrangement permits the pressure relief device to be rotated into a position in which gravitational effects can assist the pressure relief mechanism employed by the device. For example where the pressure relief device is an air admittance valve, the movement of the valve member away from the valve member seat is usefully assisted by gravitational pull. Rotatably mounting the pressure relief device to the tubular body allows for the apparatus to be used in horizontal and vertical orientations depending on the installation location.

In at least one embodiment, the at least one pressure relief device may be located on a boss provided on an upper portion of the tubular body.

The at least one pressure relief device may be configured to be removed from the body to provide access to the body for cleaning. Thus, blockages in the waste pipe system may be investigated and cleared without breaking into the system.

The inlet and outlet may be configured to facilitate retrofitting of the apparatus in an existing waste pipe system. For example, the inlet and outlet may comprise female fittings to permit the apparatus to be inserted between two pipe ends created by cutting a section of appropriate length from an existing pipe.

The apparatus may be relatively compact and may be fitted in the most appropriate location in a waste pipe system. For multi-unit applications, the apparatus may be fitted in the waste pipe system of a unit between the last fitting or appliance and the soil stack, thus isolating the waste pipe system within the unit from any pressure imbalances in the soil stack.

The one-way valve may comprise a flapper biased towards a closed position in which the upstream side of the flapper contacts a seat.

The flapper may be pivotally mounted on a collar and the seat formed by an upstream face of the collar.

In one embodiment, the collar has a peripheral lip which engages in a shoulder formed in the tubular body.

An access may be provided in the tubular body for inspection and cleaning.

The access may be provided by removing at least one of the at least one pressure relief devices.

In one embodiment, the access may be provided by removal of an air valve.

In alternative or additional embodiments, the access may be provided by the removal of an expansion chamber.

The apparatus may comprise a plurality of pressure relief devices.

In a preferred embodiment, the apparatus may comprise a first pressure relief device and a second pressure relief device.

The first pressure relief device may be located downstream of the one-way valve and the second pressure relief device may be located upstream of the one-way valve.

One of the first and second pressure relief devices may be an air admission valve and the other of the first and second pressure relief devices may be a variable volume expansion chamber.

Where there is a plurality of pressure relief devices, the pressure relief devices may be interchangeable.

According to a second aspect of the present invention there is provided a method of protecting a waste pipe system from pressure fluctuations comprising:

connecting an inlet of a tubular body to an upstream waste pipe system and an outlet of the body to a downstream waste pipe system;

providing a one-way valve in the body;

providing at least one pressure relief device on a portion of the body;

closing the one-way valve in response to positive pressure in the downstream waste pipe system; and

activating the at least one pressure relief device in response to negative pressure in the waste pipe system.

According to a third aspect of the present invention there is provided a method of protecting a waste pipe system from pressure fluctuations comprising:

connecting an inlet of a tubular body to an upstream waste pipe system and an outlet of the body to a downstream waste pipe system;

providing a one-way water valve in the body;

providing an air valve on an upper portion of the body;

closing the one-way water valve in response to positive pressure in the downstream waste pipe system; and

opening the air valve in response to negative pressure in the waste pipe system.

According to a fourth aspect of the present invention there is provided plumbing apparatus for incorporation in a waste pipe system, the apparatus comprising:

a tubular body having an inlet for connection to an upstream waste pipe and an outlet for connection to a downstream waste pipe;

a one-way valve in the body arranged to permit flow from the inlet to the outlet and to restrict flow from the outlet to the inlet, and

an air valve on an upper portion of the body arranged to permit flow of air into the body and to restrict flow of air out of the body.

According to a fifth aspect of the present invention there is provided plumbing apparatus for incorporation in a waste pipe system, the apparatus comprising:

a tubular body having an inlet for connection to an upstream waste pipe and an outlet for connection to a downstream waste pipe;

a one-way valve in the body arranged to permit flow from the inlet to the outlet and to restrict flow from the outlet to the inlet, and

a variable volume expansion chamber on an upper portion of the body arranged to permit flow of air into the body and to restrict flow of air out of the body.

### BRIEF DESCRIPTION OF THE DRAWING

This and other aspects of the invention will now be described, by way of example only, with reference to the accompanying drawings, in which:

FIG. 1 is a sectional view of plumbing apparatus in accordance with a first embodiment of the present invention: and

FIG. 2 is a sectional view of plumbing apparatus in accordance with a second embodiment of the present invention.

### DETAILED DESCRIPTION OF THE DRAWINGS

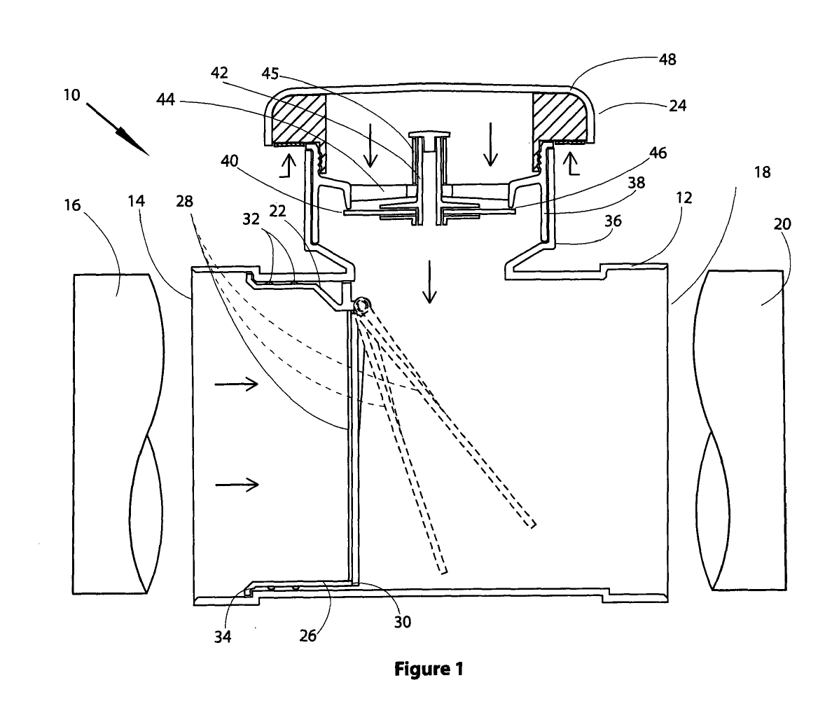

Reference is first made to FIG. 1, which is a sectional view of plumbing apparatus for incorporation in a waste pipe system in accordance with a first embodiment of the present invention. The apparatus is in the form of a pipe fitting 10 comprising a tubular body 12 having an inlet 14 for connection to an upstream waste pipe 16 and an outlet 18 for connection to a downstream waste pipe 20. The body 12 accommodates a one-way water valve 22 arranged to permit flow from the inlet 14 to the outlet 18 and to prevent flow from the outlet 18 to the inlet 14. An air valve 24 is mounted on an upper portion of the body 12 and is arranged to permit flow of air into the body 12 and to prevent flow of air out of the body 12.

The inlet 14 and outlet 18 are in the form of female connectors and thus may receive the upstream and downstream waste pipe ends 16, 20. The fitting 10 may be incorporated in a waste pipe system during the construction of the system, or may be retrofitted to an existing system, for example by cutting a section out of an existing pipe length. The inlet and outlet 14, 18 may be provided with appropriate seals for engaging and sealing with the pipe ends, or other arrangements may be provided for forming a seal, for example a settable sealing material which cures or otherwise hardens, or appropriate sealing tape.

The one-way water valve 22 includes a collar 26 and a flapper 28 which is pivotally mounted to an upper portion of the collar 26. A light spring biases the flapper 28 towards a vertical, closed position, in which the outer portion of the upstream side of the flapper 28 contacts a seat 30 defined by the collar 26.

The collar 26 carries external circumferential seals 32 for engaging the inner surface of the body 12, adjacent the inlet 14. A radially-extending lip 34 on the collar 26 cooperates with the inlet connector to control the location of the collar 26 in the body 12 during assembly. Once fitted into the pipe system, the upstream pipe end also serves to locate and secure the collar 26.

The air valve 24 is located on a boss 36 provided on a central upper portion of the body, the boss 36 tapering to a circular opening downstream of the water valve 22. The air valve 24 includes a cylindrical collar 38 sized fit closely inside the boss 36, but which allows the valve 24 to be removed if desired to permit inspection and cleaning of the waste pipe system. A valve disc 40 is mounted on the lower end of a post 42 which is itself vertically slidably mounted in a spider arrangement 44 which extends radially inwards from the collar 38. The post 42 is biased upwards by a spring 45 mounted around the post 42 to urge the valve disc 40 into contact with a seat 46.

The upper end of the air valve 24 is formed by a mushroom-shaped cap 48 which fits into the collar 38. The circumferential outer edge of the cap 48 extends beyond the collar 38 and defines a downwardly directed opening 50 which is covered by a stainless steel mesh 52.

In use, as noted above, the apparatus is incorporated in a waste pipe system, for example between the pipe carrying waste water from an apartment unit and the soil stack which links the individual apartment waste pipe systems. Due to the provision and arrangement of the valves 22, 24, the apparatus 10 protects the local waste pipe system from both negative and positive downstream pressure in the soil stack. In the event of negative pressure in the soil stack, the air valve 24 opens to allow air to be drawn into the system. Thus, fittings and appliances upstream of the apparatus 10 are not exposed to the negative pressure. Similarly, in the event of positive pressure in the soil stack, the one-way water valve 22 closes and fittings and appliances upstream of the apparatus 10 are not exposed to the positive pressure.

If the apparatus 10 is being retrofitted to a waste water system in response to pressure-related problems, it is not necessary to identify whether the problem is related to negative or positive pressure; the apparatus 10 provides a solution to both problems.

The one-way water valve 22 also serves to prevent waste water which has backed up in the soil pipe, or in other parts of the downstream waste pipe system, from passing into the upstream waste pipe system. Furthermore, the one-way water valve 22 also serves as a barrier to prevent rodents gaining access to the upstream waste pipe system.

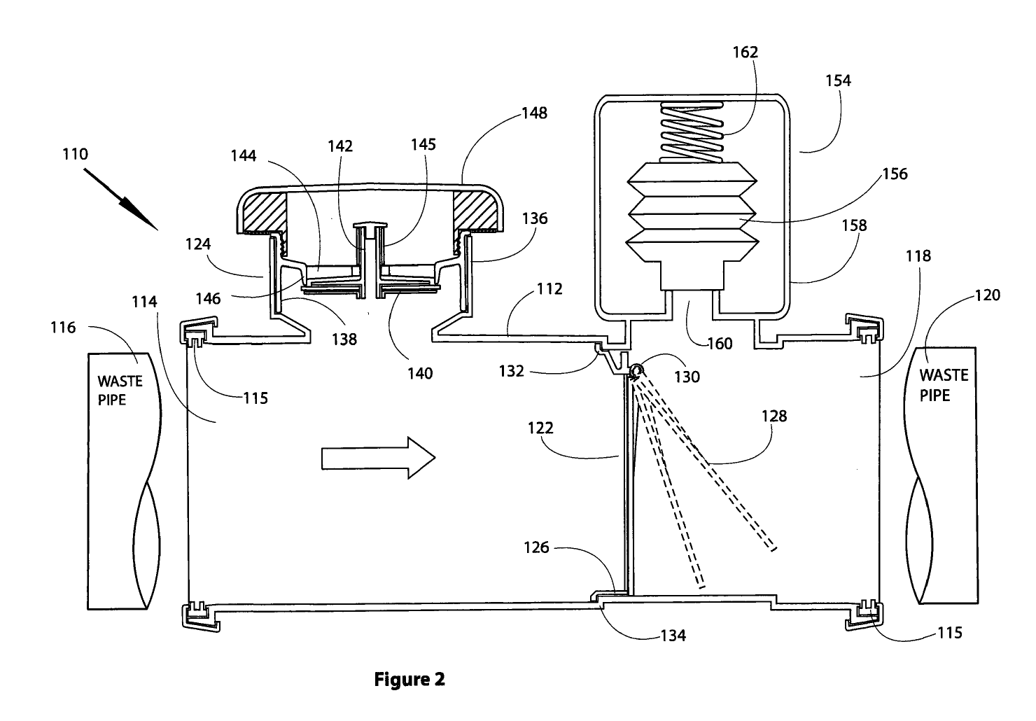

Referring now to FIG. 2, a second plumbing apparatus 110 is shown in accordance with a second embodiment of the present invention.

The apparatus is in the form of a pipe fitting 110 comprising a tubular body 112 having an inlet 114 for connection to an upstream waste pipe 116 and an outlet 118 for connection to a downstream waste pipe 120. The body 112 accommodates a one-way waste valve or water valve 122 arranged to permit flow from the inlet 114 to the outlet 118 and to prevent flow in the reverse direction.

A one-way air valve 124 is mounted on an upper portion of the body 112 and is arranged to permit flow of air from the surroundings into the body 112 and to prevent flow in the reverse direction. The air valve 124 communicates with the interior of the body 112 at a location upstream of the water valve 122.

A variable volume expansion chamber is provided, in this embodiment, by a bellows assembly 154 located downstream of the water valve 122.

The inlet 114 and outlet 118 are in the form of female connectors and thus may receive the upstream and downstream waste pipe ends 116, 120. The fitting 110 may be incorporated in a waste pipe system during construction, or may be retrofitted to an existing system for example by cutting a section out of an existing pipe length.

The inlet and outlet 114, 118 are provided with resilient seals 115 for engaging and sealing with the pipe ends; alternatively other arrangements may be provided for forming a seal, for example a settable sealing material or an appropriate tape.

The one-way water valve 122 includes a collar 126 and a flapper 128 which is pivotally mounted to an upper portion of the collar 126. A light spring 130 biases the flapper 128 towards a vertical closed position, in which the outer portion of the upstream side of the flapper 128 contacts a seat 131 defined by the collar 126.

A radially extending lip 132 on the collar 126 locates against a shoulder 134 formed in the tubular body 112.

The air valve 124 is located on a boss 136 on a central upper portion of the tubular body 112, the boss tapering to a circular opening upstream of the water valve 122. The air valve 124 includes a cylindrical collar 138 sized to fit closely inside the boss 136, but which allows the valve 124 to be removed if desired to permit inspection and cleaning of the waste system. A valve disc 140 is mounted on the lower end of a post 142 which is itself vertically slidable in a spider 144 which extends radially inwards from the collar 138. The post 142 is biased upwardly by a spring 145 mounted around the post 142 to urge the valve disc 140 into contact with a seat 146.

The upper end of the air valve 124 is formed by a mushroom-shaped cap 148 which fits into the collar 138. The outer edge of the cap 148 extends beyond the collar 138 and the overhanging portion is provided with air vents (not seen in the drawing).

The bellows assembly 154 comprises a flexible bellows 156 contained within a housing 158. The interior of the bellows 156 communicates with the interior of the body 112 via a port 160 located downstream of the water valve 122. The bellows 156 is loaded by a compression spring 162.

In use, the apparatus is incorporated in a waste pipe system, typically between the pipe carrying waste water from an individual apartment unit and a soil stack common to a number of units. The apparatus protects the local waste pipe system from both positive and negative pressure downstream in the system. In the event of negative pressure, the air valve 124 opens to admit air to relieve the negative pressure. In the event of positive stack pressure, the water valve 122 will close and the bellows 156 will expand to reduce the overpressure. Once the pressure drops, the bellows will contract to expel air. The bellows thus acts to reduce transient loadings on the water valve.

Modifications may be made to the foregoing embodiments within the scope of the invention. For example, a variable volume expansion means other than a bellows may be used, such as an elastomeric bladder or a piston and cylinder arrangement. Other forms of one-way air admittance valve could be used. An inspection and cleaning access could be provided at the bellows rather than at the air valve, or separately, or could be dispensed with.

In another modification, the bellows assembly (or other variable volume expansion means) is mounted on a boss similar to that used for the air admittance valve so as to be removable, for example by means of slidably engagable pipe sections provided with an 0-ring. This allows the user to fit only one of the air admittance valve and bellows, depending on the needs of the installation, the other boss being closed off with a blanking plate or cap.

A further modification relates to the fact that the air valve is designed to be oriented vertically, being gravity-assisted in operation. In the embodiment described above, the assembly is fitted in a horizontal waste pipe. However there are situations where it would be convenient to fit the assembly in a vertical stack. To enable this, a right-angle pipe section may be fitted between the boss and the valve; the boss and the valve may be modified to accept a standard push-fit 90° bend.

1. Plumbing apparatus for incorporation in a waste pipe system, the apparatus comprising:
a tubular body having an inlet for connection to an upstream waste pipe and an outlet for connection to a downstream waste pipe;
a one-way valve in the body arranged to permit flow from the inlet to the outlet and to restrict flow from the outlet to the inlet, and
at least one pressure relief device on a portion of the body arranged to permit the flow of air into the body and to restrict flow of air out of the body.

2. The apparatus of claim 1, wherein the at least one pressure relief device is in communication with the body downstream of the one-way valve.

3. The apparatus of claim 1 or 2, wherein the at least one pressure relief device is an air valve.

4. The apparatus of claim 3, wherein the air valve is a one way air admission valve.

5. The apparatus of claim 3 or 4, wherein the air valve is located on a boss provided on an upper portion of the body.

6. The apparatus of claim 5, wherein the boss tapers to an opening downstream of the one-way valve.

7. The apparatus of claim 5 or 6, wherein the air valve includes a cylindrical collar sized to fit closely inside the boss.

8. The apparatus of claim 7, further comprising a valve disc mounted on the lower end of a post, the post being vertically slidably mounted in a spider arrangement which extends radially inwards from the collar.

9. The apparatus of claim 8, wherein the post is biased upwards by a spring to urge the valve disc into contact with a seat.

10. The apparatus of claim 7, 8 or 9, wherein the upper end of the air valve is formed by a cap which fits into the collar.

11. The apparatus of claim 10, wherein the circumferential outer edge of the cap extends beyond the collar and defines a downwardly directed opening

12. The apparatus of claim 11, wherein the opening is covered by a mesh.

13. The apparatus of claim 1 or 2, wherein at least one pressure relief device is a variable volume expansion chamber.

14. The apparatus of claim 13, wherein variable volume expansion chamber comprises a bellows.

15. The apparatus of claim 14, wherein bellows is mounted on a port open to the interior of the tubular body.

16. The apparatus of claim 14 or 15, wherein bellows is enclosed within a housing.

17. The apparatus of claim 16, wherein the variable volume expansion chamber comprises an elastomeric bladder or a piston and cylinder.

18. The apparatus of any preceding claim, wherein apparatus comprises a plurality of pressure relief devices.

19. The apparatus of claim 18, wherein, the apparatus comprises a first pressure relief device and a second pressure relief device.

20. The apparatus of claim 19, wherein first pressure relief device is located downstream of the one-way valve and the second pressure relief device is located upstream of the one-way valve.

21. The apparatus of claim 19 or 20, wherein one of the first and second pressure relief devices is an air valve and the other of the first and second pressure relief devices is a variable volume expansion chamber.

22. The apparatus of any claims 18 to 21, wherein, where there are a plurality of pressure relief devices, the pressure relief devices are interchangeable.

23. The apparatus of any preceding claim, the at least one pressure relief device comprises a pressure relief mechanism.

24. The apparatus of claim 23, wherein the pressure relief device is located on the tubular body such that in a preferred installation orientation, gravitational effects assist the pressure relief mechanism to operate.

25. The apparatus of claim 24, wherein where the preferred installation orientation is horizontal, the pressure relief device is mounted on an upper portion of the tubular body.

26. The apparatus of any preceding claim, wherein the at least one pressure relief device is rotatably mounted to the tubular body.

27. The apparatus of any preceding claim, wherein an access is provided in the tubular body for inspection and cleaning.

28. The apparatus of claim 27, wherein the access is provided by removing at least one of the at least one pressure relief devices.

29. The apparatus of claim 28, wherein the access is provided by removal of an air valve.

30. The apparatus of claim 27 or 28, wherein the access is provided by the removal of a variable expansion chamber.

31. The apparatus of claim any preceding claim, wherein the inlet and outlet are configured to facilitate retrofitting of the apparatus in an existing waste pipe system.

32. The apparatus of claim 31, wherein the inlet and outlet comprise female fittings to permit the apparatus to be inserted between two pipe ends created by cutting a section of appropriate length from an existing pipe.

33. The apparatus of any preceding claim, wherein air valve comprises a valve member resiliently biased against a seat.

34. The apparatus of claim 33, wherein the one-way valve includes a flapper.

35. The apparatus of claim 34, wherein the flapper is biased towards a closed position in which the upstream side of the flapper contacts a seat.

36. The apparatus of claim 34 or 35, wherein the flapper is pivotally mounted to a collar.

37. The apparatus of claim 36, wherein the collar carries external circumferential seals for engaging an inner surface of the body.

38. The apparatus of claim 36 or 37, wherein a radially-extending lip is provided on the collar and cooperates with an inlet connector to control the location of the collar in the body.

39. The apparatus of claim 38, wherein the upstream pipe end locates and secures the collar in the body.

40. A method of protecting a waste pipe system from pressure fluctuations comprising:
connecting an inlet of a tubular body to an upstream waste pipe system and an outlet of the body to a downstream waste pipe system;
providing a one-way valve in the body;
providing at least one pressure relief device on a portion of the body;
closing the one-way valve in response to positive pressure in the downstream waste pipe system; and
activating the at least one pressure relief device in response to negative pressure in the waste pipe system.

41. The method of claim 40, comprising closing the one-way valve to prevent waste water passing from the downstream waste pipe system into the upstream waste pipe system.

42. The method of claim 40 or 41, comprising biasing the one-way valve towards a closed position.

43. The method of claim 40, 41 or 42, comprising removing the at least one pressure relief device from the body to create an access opening providing access to the body.

44. The method of claim 43, further comprising inspecting or cleaning the waste pipe system via the access opening.

45. The method of any of claims 40 to 44, comprising retrofitting the body in an existing waste pipe system.

46. The method of claim 45, comprising inserting the body between two pipe ends created by cutting a section of appropriate length from an existing pipe.

47. The method of any of claims 40 to 46, comprising fitting the apparatus in the waste pipe system of a unit between the last fitting or appliance and the soil stack.

48. Plumbing apparatus for incorporation in a waste pipe system substantially as described and as illustrated in the accompanying drawing.

49. A waste pipe system incorporating plumbing apparatus substantially as described herein.

50. A method of protecting a waste pipe system from pressure fluctuations substantially as described herein.
